(19) United States
(12) Patent Application Publication
(10) Pub. No.: US 2025/0206279 A1
(43) Pub. Date: Jun. 26, 2025

(54) BRAKING APPARATUS FOR VEHICLE

(71) Applicant: HYUNDAI MOBIS CO., LTD., Seoul (KR)

(72) Inventors: Sung Ki AHN, Yongin-si (KR); Young Chang CHOI, Yongin-si (KR); Jeong Hoon BAE, Yongin-si (KR)

(73) Assignee: HYUNDAI MOBIS CO., LTD., Seoul (KR)

(21) Appl. No.: 18/768,542

(22) Filed: Jul. 10, 2024

(30) Foreign Application Priority Data
Dec. 20, 2023 (KR) 10-2023-0187052

(51) Int. Cl. B60T 13/16; B60T 13/18

(52) U.S. Cl. CPC B60T 13/161; B60T 13/168; B60T 13/18

(57) ABSTRACT

A braking apparatus includes a pedal configured to be pressed by a driver to cause braking, a master cylinder part in which pressure of oil is amplified by the pressure applied to the pedal part, a block part configured to be supplied with the oil from the master cylinder. An electric pump part is inserted into block part and is configured to amplify the pressure of the oil in the block part. A wheel cylinder part is connected to the block part that is configured to receive pressurized oil from the block part and to generate a braking force for a wheel. The block part defines a space into which the electric pump part is inserted and a plurality of oil movement paths that are connected to the space and separate from each other when the electric pump part is inserted into the space.

### CROSS-REFERENCE TO RELATED APPLICATIONS

This application claims priority from and the benefit of Korean Patent Application No. 10-2023-0187052, filed on Dec. 20, 2023, which is hereby incorporated by reference for all purposes as set forth herein.

### TECHNICAL FIELD

Exemplary embodiments of the present disclosure relate to a braking apparatus for a vehicle, and more particularly, to a braking apparatus for a vehicle, which can directly control a discharge flow rate of oil that is discharged by an electric pump because a shared hydraulic line is separately provided.

### BACKGROUND

In general, an electric hydraulic brake system adjusts braking pressure of each wheel by fluid pressure of a master cylinder that is driven by a motor after a driver's pedal pressure is sensed through a sensor.

The electric hydraulic brake system includes the sensor for sensing the stroke distance of a pedal so that a driver can be aware of desired braking pressure. The electric hydraulic brake system includes a pedal travel simulator that enables a driver to feel the same pedal pressure as in a common hydraulic brake apparatus. Accordingly, when the driver steps on the brake pedal, an electronic control unit supplies fluid pressure to the master cylinder by sensing the stepping of the brake pedal. The master cylinder provides a braking force to each wheel by transmitting braking fluid pressure to the wheel cylinder of each wheel.

A conventional electric hydraulic brake system has a problem in that it is difficult to increase pressure or a pulsation phenomenon is caused because a flow channel for braking does not actively handle braking fluid pressure according to revolution per minute (RPM) of a motor. Furthermore, the conventional electric hydraulic brake system has a problem in that it is difficult to directly control a discharge flow rate of a pump output part when a flow channel that provides oil that is discharged by the master cylinder with guidance and a flow channel that provides oil that is discharged by the motor with guidance are used in common. Accordingly, there is a need to solve the problem.

### SUMMARY

Various embodiments are directed to providing a braking apparatus for a vehicle, which can directly control a discharge flow rate of oil that is discharged by an electric pump because a shared hydraulic line is separately provided.

In an embodiment, a braking apparatus for a vehicle may include a pedal part configured to be pressed by a driver to cause braking, a master cylinder part in which pressure of oil is amplified by the pressure applied to the pedal part, a block part configured to receive the oil form the master cylinder part, and an electric pump part inserted into the block part and configured to amplify the pressure of the oil in the block part. A wheel cylinder part is connected to the block part that is configured to receive pressurized oil from the block part and to generate a braking force for a wheel in response to receiving the pressurized oil. The block part defines a space into which the electric pump part is inserted. The block part also defines a plurality of oil movement paths that are fluidly connected to the space. The oil movement paths are separated from each other when the electric pump part is inserted into the space.

The block part may include a block body part, the space may comprise a pump port part (also referred to as a pump port) formed in the block body part and configured to have the electric pump part mounted therein, and the plurality of oil movement flow paths may include a wheel flow channel part, a supply flow channel part, and a pump flow channel part. The wheel flow channel part (also referred to as a wheel flow channel) is formed in the block body part and configured to communicate with the pump port part and to provide oil with guidance to the wheel cylinder part; the supply flow channel part (also referred to as a supply flow channel) is formed in the block body part and configured to provide oil with guidance to the electric pump part by connecting the wheel flow channel part and the pump port part; and the pump flow channel part (also referred to as a pump flow channel) formed in the block body part and configured to connect the pump port part and the wheel flow channel part and to provide oil that is discharged by the electric pump part with guidance.

The pump port part may include a pump mounting port part formed in a first surface of the block body part and a pump connection port part formed in a second surface of the block body part, configured to communicate with the pump mounting port part, and connected to the supply flow channel part, the wheel flow channel part, and the pump flow channel part.

The pump connection port part may include a first chamber part configured to communicate with the pump mounting port part, a second chamber part extended from the first chamber part and configured to communicate with the supply flow channel part, a third chamber part extended from the second chamber part and configured to communicate with the wheel flow channel part, and a fourth chamber part extended from the third chamber part to the second surface and configured to communicate with the pump flow channel part.

An inside diameter of the second chamber part may be designed to be greater than an inside diameter of the first chamber part. An inside diameter of the third chamber part may be designed to be greater than the inside diameter of the second chamber part. An inside diameter of the fourth chamber part may be designed to be greater than the inside diameter of the third chamber part.

An incline may be formed at a boundary part between the third chamber part and the fourth chamber part.

The electric pump part may include an electric part mounted in the pump mounting port part and driven when power is applied thereto and a pump part mounted in the pump connection port part and configured to discharge oil that is introduced by the electric part by increasing pressure of the oil.

The pump part may include a pump compression part inserted into the first chamber part and the second chamber part and configured to raise pressure of oil that is introduced into the second chamber part while being reciprocated by the electric part, a pump guide part connected to the pump compression part and configured to seal the third chamber part and to provide oil that is discharged by the pump compression part with guidance, and a pump discharge part connected to the pump guide part, inserted into the fourth chamber part, and configured to discharge oil that passes through the pump guide part.

The braking apparatus according to an embodiment of the present disclosure may further include a variable valve part mounted on the block part and configured to adjust an amount of passage of oil based on a flow rate of the oil that is discharged by the electric pump.

The variable valve part may include an external valve part via which oil enters the variable valve part and an internal valve part movably supported within the external valve and defining an inner oil flow path through a central portion of the internal valve part. The internal valve part is supported such that an outer oil flow path is defined between an inner surface of the external valve part and an outer surface of the internal valve part. The internal valve part is movable between a first position at which the outer flow path is closed and a second position at which the outer flow path is open. A cover valve part is attached to the external valve part and defines an open via which oil received from the inner oil flow path and the outer oil flow path is discharged from the variable valve part. An adjustment valve part is disposed between the internal valve part and the cover valve part and is configured to bias the internal valve part toward the first position.

In the braking apparatus for a vehicle according to an embodiment of the present disclosure, a plurality of oil paths can be designed because the electric pump part is mounted on the block part and partitions the chamber, and pressure pulsation amplitude can be reduced because the oil movement path is varied according to a flow rate.

### BRIEF DESCRIPTION OF THE DRAWINGS

FIG. 1 is a diagram schematically illustrating a braking apparatus for a vehicle according to an embodiment of the present disclosure.

FIG. 2 is a diagram schematically illustrating a block part according to an embodiment of the present disclosure.

FIG. 3 is a diagram schematically illustrating a pump port part according to an embodiment of the present disclosure.

FIG. 4 is a diagram schematically illustrating an electric pump part according to an embodiment of the present disclosure.

FIG. 5 is a diagram schematically illustrating the state in which the electric pump part has been inserted into the pump port part according to an embodiment of the present disclosure.

FIG. 6 is a diagram schematically illustrating a metal sealing section between the pump port parts of the electric pump part according to an embodiment of the present disclosure.

FIG. 7 is a diagram schematically illustrating the state in which a variable valve part has been added in FIG. 1.

FIG. 8 is a diagram schematically illustrating a pump flow channel part that is formed in a block body part according to an embodiment of the present disclosure.

FIG. 9 is a combined cross-sectional view schematically illustrating the variable valve part according to an embodiment of the present disclosure.

FIG. 10 is an exploded cross-sectional view schematically illustrating the variable valve part according to an embodiment of the present disclosure.

FIG. 11 is a diagram schematically illustrating the state in which a small amount of oil passes through the variable valve part according to an embodiment of the present disclosure.

FIG. 12 is a diagram schematically illustrating the state in which a large amount of oil passes through the variable valve part according to an embodiment of the present disclosure.

FIG. 13 is a diagram schematically illustrating the state in which the countercurrent of oil through the variable valve part according to an embodiment of the present disclosure is prevented.

### DETAILED DESCRIPTION

Hereinafter, a braking apparatus for a vehicle according to an embodiment of the present disclosure will be described with reference to the accompanying drawings. In this process, the thicknesses of lines or the sizes of components illustrated in the drawings may have been exaggerated for the clarity of a description and for convenience' sake. Terms to be described below have been defined by taking into consideration their functions in the present disclosure, and may be changed depending on a user or operator's intention or practice. Accordingly, such terms should be defined based on the overall contents of this specification.

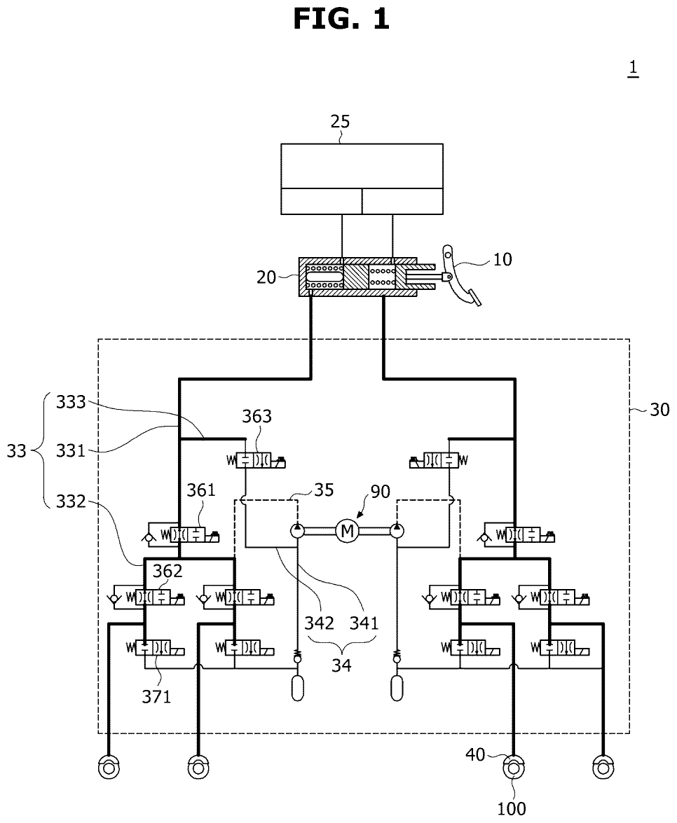

FIG. 1 is a diagram schematically illustrating a braking apparatus for a vehicle according to an embodiment of the present disclosure. Referring to FIG. 1, a braking apparatus 1 for a vehicle according to an embodiment of the present disclosure includes a pedal part 10, a master cylinder part 20, a block part 30, and a wheel cylinder part 40.

The pedal part 10 may be pressed by a driver to cause braking of the vehicle. For example, the pedal part 10 may be disposed within a vehicle body. A driver may step on the pedal part 10 while driving.

The master cylinder part 20 may amplify the pressure of oil based on movement of the pedal part 10. For example, the master cylinder part 20 may amplify the pressure of oil stored therein as a cylinder in which two chambers have been formed is pressurized while operating in conjunction with the pedal part 10. The master cylinder part 20 may be connected to a storage unit 25 in which oil is stored.

The block part 30 may be connected to the master cylinder part 20 and supplied with oil. As power is applied to the block part 30, an electric pump part 90 may amplify the pressure of the oil. For example, a hydraulic circuit that induces oil supplied by the master cylinder part 20 to be discharged after being supplied to the electric pump part 90 may be formed in the block part 30.

As the electric pump part 90 is inserted into the block part 30, a plurality of oil movement paths may be implemented. That is, the plurality of oil movement paths may be connected to the space of the block part 30 into which the electric pump part 90 is inserted. When the electric pump part 90 is inserted into the insertion space, the insertion space may be partitioned, so that the plurality of oil movement paths is separated, so as not to be mixed together.

The wheel cylinder part 40 may be connected to the block part 30, and may provide a braking force to a wheel 100. For example, when oil having high pressure is supplied to the wheel cylinder part 40, a braking force may be generated in the wheel 100.

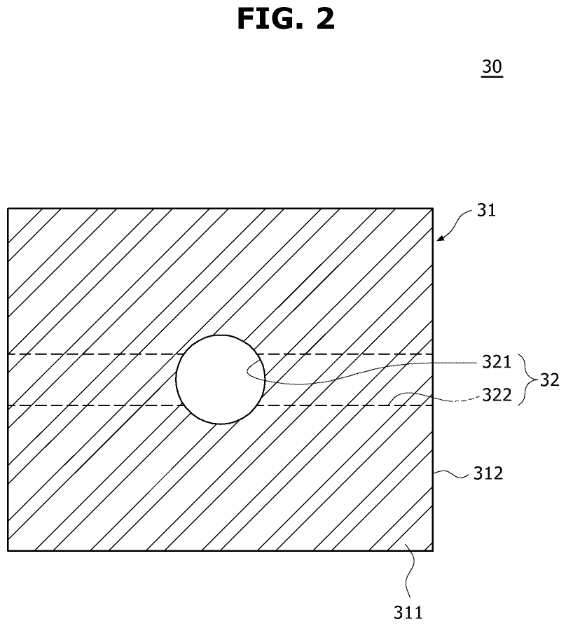

FIG. 2 is a diagram schematically illustrating the block part according to an embodiment of the present disclosure. Referring to FIGS. 1 and 2, the block part 30 according to an embodiment of the present disclosure may include a block body part 31, a pump port part 32, a wheel flow channel part 33, a supply flow channel part 34, and a pump flow channel part 35.

The block body part 31 may be used to provide a braking force for anti-locking and a driving dynamic control system. For example, the block body part 31 may be mounted on a vehicle body, and may be composed of a square block that is manufactured by an extrusion molding method and subjected to a cutting process and that is made of an aluminum alloy. The block body part 31 may include a first surface 311 and a second surface 312 having a smaller surface area than the first surface 311.

The pump port part 32 may be formed in the block body part 31. The electric pump part 90 may be mounted on the pump port part 32. For example, the pump port part 32 may be an installation space that is formed in the block body part 31.

The wheel flow channel part 33 may be formed in the block body part 31, and may communicate with the pump port part 32. The wheel flow channel part 33 may provide oil with guidance to the wheel cylinder part 40. For example, the wheel flow channel part 33 may include a first wheel flow channel part 331, a second wheel flow channel part 332, and a third wheel flow channel part 333. The first wheel flow channel part 331 may have one end part connected to a line that provides oil supplied by the master cylinder part 20 with guidance, and may have the other end part opened and closed by a first wheel valve part 361. The second wheel flow channel part 332 may have one end part connected to the first wheel valve part 361, may have the other end part connected to a line that provides oil with guidance to the wheel cylinder part 40, and may be opened and closed by the second wheel valve part 362. The third wheel flow channel part 333 may have one end part connected to the first wheel flow channel part 331, and may have the other end part opened and closed by a third wheel valve part 363.

The supply flow channel part 34 may be formed in the block body part 31, and may provide oil with guidance to the electric pump part 90 by connecting the wheel flow channel part 33 and the pump port part 32. For example, the supply flow channel part 34 may include a first supply flow channel part 341 and a second supply flow channel part 342. The first supply flow channel part 341 may connect a first supply valve part 371 that opens and closes the second wheel flow channel part 332 and the pump port part 32. An accumulator for temporarily storing oil may be connected to the first supply flow channel part 341. The second supply flow channel part 342 may connect the third wheel valve part 363 and the first supply flow channel part 341.

The pump flow channel part 35 may be formed in the block body part 31, may connect the pump port part 32 and the wheel flow channel part 33, and may provide oil that is discharged by the electric pump part 90 with guidance. For example, one end part of the pump flow channel part 35 may be connected to the pump port part 32. The other end of the pump flow channel part 35 may be connected to the second wheel flow channel part 332.

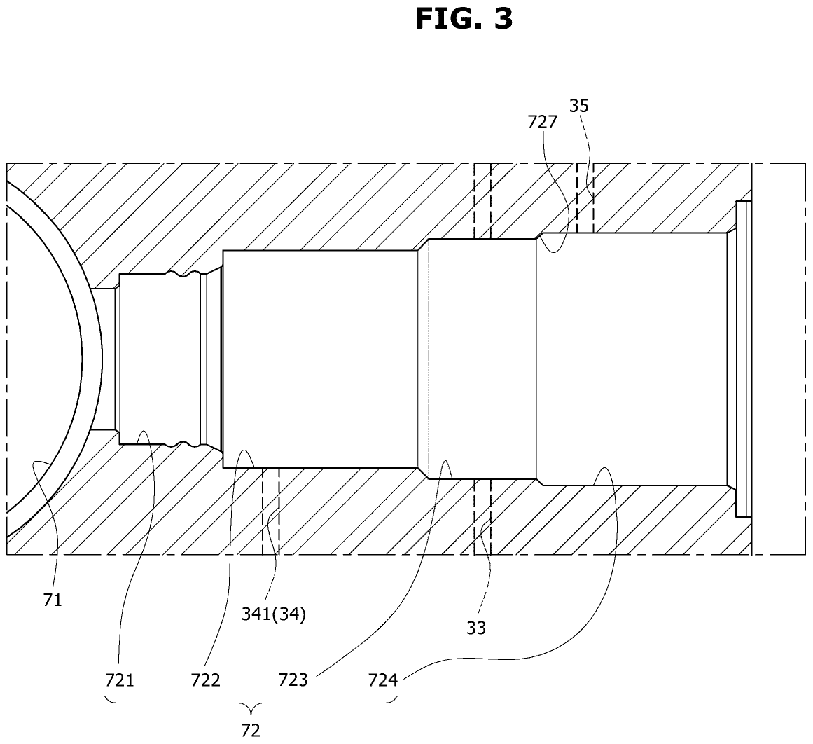

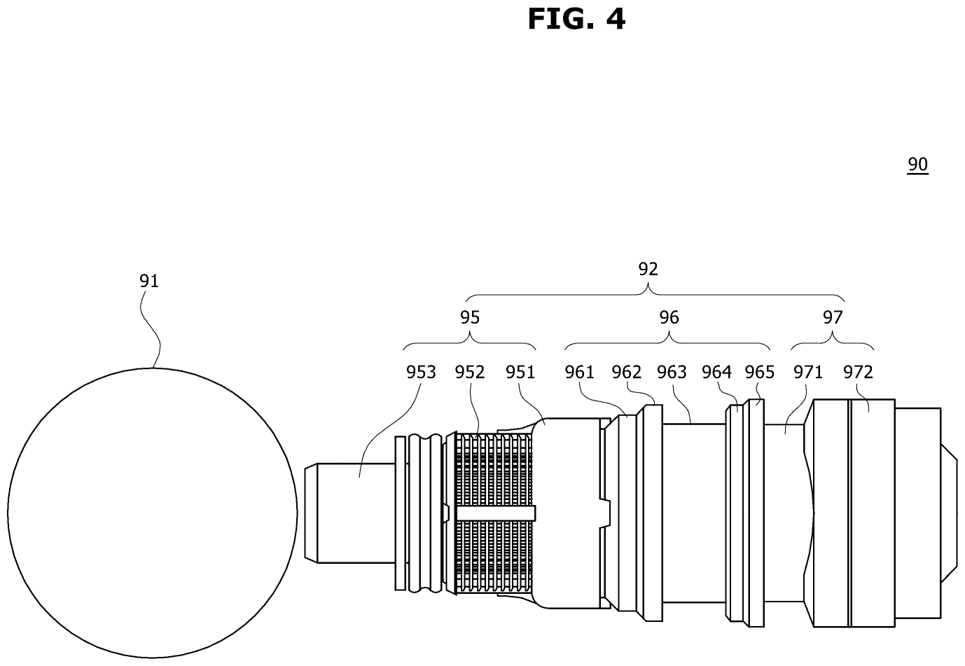

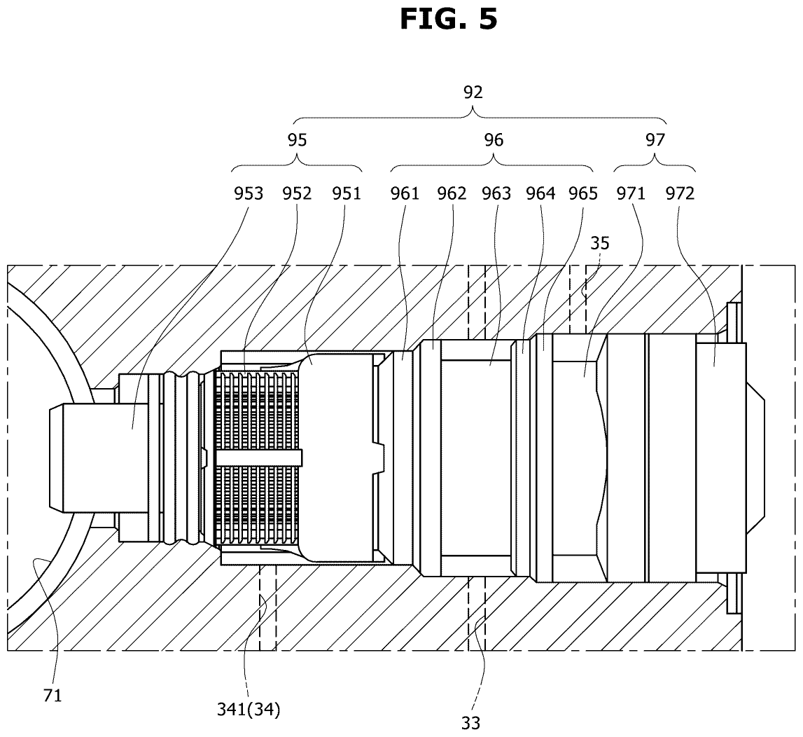

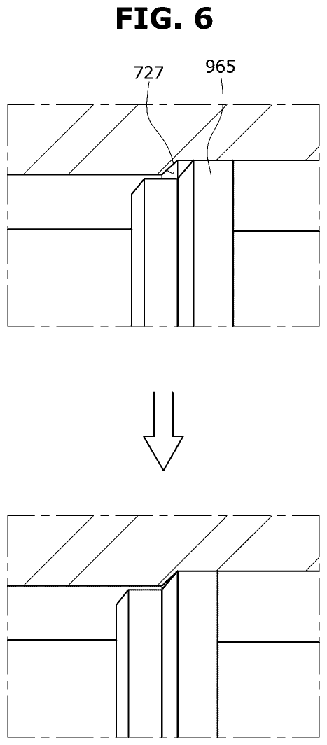

FIG. 3 is a diagram schematically illustrating a pump port part according to an embodiment of the present disclosure. FIG. 4 is a diagram schematically illustrating the electric pump part according to an embodiment of the present disclosure. FIG. 5 is a diagram schematically illustrating the state in which the electric pump part has been inserted into the pump port part according to an embodiment of the present disclosure. FIG. 6 is a diagram schematically illustrating a metal scaling section between the pump port parts of the electric pump part according to an embodiment of the present disclosure. Referring to FIGS. 3 to 6, the pump port part 32 according to an embodiment of the present disclosure may include a pump mounting port part 71 and a pump connection port part 72.

The pump mounting port part 71 may be formed in a first surface 311 of the block body part 31. For example, the first surface 311 may be a front or rear surface having a relatively wide surface area in the block body part 31 having a hexahedral shape. The pump mounting port part 71 may be formed at a central part of the first surface 311.

The pump connection port part 72 may be formed in a second surface 312 of the block body part 31, and may communicate with the pump mounting port part 71. The wheel flow channel part 33, the supply flow channel part 34, and the pump flow channel part 35 may be connected to the pump connection port part 72. For example, the second surface 312 may be any one or more of four sides each having a smaller surface area than each of a front surface and a rear surface in the block body part 31 having a hexahedral shape. The pump connection port part 72 may be obtained by processing a surface of the second surface 312, and may communicate with the pump mounting port part 71. One pump connection port part 72 may be a shared path of oil that is moved through the wheel flow channel part 33, the supply flow channel part 34, and the pump flow channel part 35.

The pump connection port part 72 according to an embodiment of the present disclosure may include a first chamber part 721, a second chamber part 722, a third chamber part 723, and a fourth chamber part 724.

The first chamber part 721 may communicate with the pump mounting port part 71. For example, the diameter of the first chamber part 721 may be increased from the pump mounting port part 71 toward the second surface 312.

The second chamber part 722 may be extended from the first chamber part 721, and may communicate with the supply flow channel part 34. The second chamber part 722 may be connected to the first supply flow channel part 341, so that oil may be supplied to the second chamber part 722.

The third chamber part 723 may be extended from the second chamber part 722, and may communicate with the wheel flow channel part 33. For example, the third chamber part 723 may be formed on any one path of the first wheel flow channel part 331, the second wheel flow channel part 332, and the third wheel flow channel part 333. When the third chamber part 723 is partitioned from the second chamber part 722 and the fourth chamber part 724 that neighbor the third chamber part 723, processing in the block body part 31 having a narrow space can be minimized, and an oil movement path can also be optimized. Two holes may communicate with the third chamber part 723 in order for oil to pass through the two holes.

The fourth chamber part 724 may be extended from the third chamber part 723 to the second surface 312, and may communicate with the pump flow channel part 35. For example, the fourth chamber part 724 may provide a space to which oil discharged by the electric pump part 90 is discharged.

An inside diameter of the second chamber part 722 may be designed to be greater than an inside diameter of the first chamber part 721. An inside diameter of the third chamber part 723 may be designed to be greater than the inside diameter of the second chamber part 722. An inside diameter of the fourth chamber part 724 may be designed to be greater than the inside diameter of the third chamber part 723. A step may be formed at each of boundary points between the second chamber part 722 and the third chamber part 723 and between the third chamber part 723 and the fourth chamber part 724 due to a change in the inside diameter.

An incline 727 may be formed at a boundary part between the third chamber part 723 and the fourth chamber part 724. The incline 727 can prevent burr from being exposed to a flow channel by restricting the burr which may occur in a process for metal scaling.

The electric pump part 90 according to an embodiment of the present disclosure may include an electric part 91 and a pump part 92.

The electric part 91 may be mounted on the pump mounting port part 71 and driven when power is supplied thereto. For example, the electric part 91 may be mounted on the first surface 311, and may cover the pump mounting port part 71.

The pump part 92 may be mounted on the pump connection port part 72, and may discharge oil that is introduced by the electric part 91 by increasing the pressure of the oil. For example, the pump part 92 may be inserted into the second surface 312, and may discharge oil that is introduced by the driving of the electric part 91, by compressing the oil.

More specifically, the pump part 92 may include a pump compression part 95, a pump guide part 96, and a pump discharge part 97.

The pump compression part 95 may be inserted into the first chamber part 721 and the second chamber part 722, and may raise the pressure of oil that is introduced into the second chamber part 722 by being reciprocated by the electric part 91. For example, the pump compression part 95 may include a compression housing part 951, a compression filter part 952, and a compression cylinder part 953. The compression housing part 951 may be embedded in the second chamber part 722. The compression filter part 952 may be provided in the compression housing part 951, and may filter out an alien substance from oil that is introduced thereto. The compression cylinder part 953 may be mounted on the compression housing part 951, and may protrude to the pump mounting port part 71 through the first chamber part 721. The compression cylinder part 953 may compress oil while being reciprocated and rotated by the electric part 91 that is eccentrically rotated.

The pump guide part 96 may be connected to the pump compression part 95, may seal the third chamber part 723, and may provide oil that is discharged by the pump compression part 95 with guidance. For example, the pump guide part 96 may include a first pump guide part 961, a second pump guide part 962, a third pump guide part 963, a fourth pump guide part 964, and a fifth pump guide part 965.

The first pump guide part 961 may be combined with the pump compression part 95 and embedded in the second chamber part 722. The first pump guide part 961 may be connected to the compression housing part 951. An outer circumferential surface of the first pump guide part 961 may be closely attached to an inner circumferential surface of the second chamber part 722.

The second pump guide part 962 may be extended from the first pump guide part 961 and embedded in the third chamber part 723. The second pump guide part 962 may be closely attached to a surface of the step that is formed in a boundary area between the second chamber part 722 and the third chamber part 723 due to a difference in the inside diameter.

The third pump guide part 963 may be extended from the second pump guide part 962 and disposed within the third chamber part 723. The third pump guide part 963 may have a pipe shape, and may provide oil with guidance to the inside of the third pump guide part 963. An outside diameter of the third pump guide part 963 may be designed to be smaller than an inner circumferential surface of the third chamber part 723. Accordingly, a space that is formed between the third chamber part 723 and the third pump guide part 963 may become a part of the wheel flow channel part 33.

An outside diameter of the fourth pump guide part 964 may be extended from the third pump guide part 963. An outer circumferential surface of the fourth pump guide part 964 may be disposed closely to the inner circumferential surface of the third chamber part 723. An O-ring may be added between the fourth pump guide part 964 and the third chamber part 723.

The fifth pump guide part 965 may be extended from the fourth pump guide part 964 and closely attached to the fourth chamber part 724. The fifth pump guide part 965 may cause burr as the fifth pump guide part 965 is moved by being closely attached to the fourth chamber part 724. The generated burr may be accumulated in the incline 727 and then pressed against the fifth pump guide part 965. Accordingly, the generated burr may not be exposed on a flow channel.

The pump discharge part 97 may be connected to the pump guide part 96, may be inserted into the fourth chamber part 724, and may discharge oil that passes through the pump guide part 96. For example, the pump discharge part 97 may include a discharge pipe part 971 and a discharge scaling part 972.

The discharge pipe part 971 may be extended from the pump guide part 96, and may discharge oil that passes through the pump guide part 96. An outside diameter of the discharge pipe part 971 may be smaller than the inside diameter of the fourth chamber part 724. A passage for discharging oil may be formed in the discharge pipe part 971.

The discharge sealing part 972 may support the discharge pipe part 971, may be mounted on the block part 30, and can prevent the breakaway of the discharge pipe part 971. For example, the discharge sealing part 972 may be pressed in the fourth chamber part 724, may support the discharge sealing part 972, and can block the leakage of oil.

Accordingly, when the pump part 92 is mounted on the pump connection port part 72, the pump connection port part 72 may be partitioned into the second chamber part 722, the third chamber part 723, and the fourth chamber part 724. Each of the second chamber part 722, the third chamber part 723, and the fourth chamber part 724 may become an oil movement path. The supply flow channel part 34 may be connected to the second chamber part 722, so that oil can be supplied to the pump part 92. The third chamber part 723 may be disposed on an oil movement path through the wheel flow channel part 33. The fourth chamber part 724 may be connected to the pump flow channel part 35 that provides discharged oil with guidance.

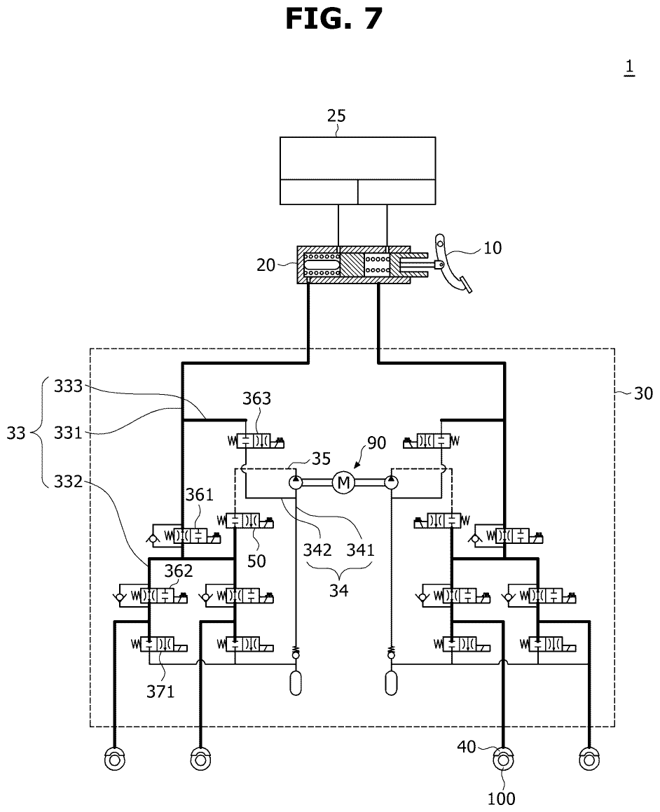

FIG. 7 is a diagram schematically illustrating the state in which a variable valve part has been added in FIG. 1. Referring to FIG. 7, the braking apparatus 1 for a vehicle according to an embodiment of the present disclosure may further include a variable valve part 50.

The variable valve part 50 may be mounted on the block part 30, and may adjust the amount of passage of oil that is discharged by the electric pump part 90 based on a flow rate of the oil. The variable valve part 50 may permit the passage of oil only in one direction. The variable valve part 50 may be disposed within the block part 30 so that the variable valve part 50 is not exposed to the outside. That is, the variable valve part 50 may be disposed in the pump flow channel part 35 that is formed within the block part 30. The oil movement path of the variable valve part 50 may be differently designed based on the amount of oil that passes through the variable valve part 50 by the driving of the electric pump part 90, enabling a pulsation reduction. The variable valve part 50 may change a flow channel through which oil passes based on the pressure of the oil.

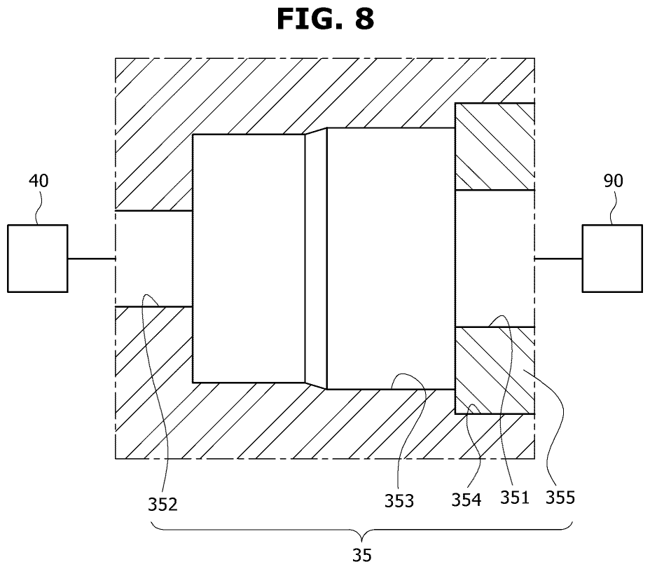

FIG. 8 is a diagram schematically illustrating the pump flow channel part that is formed in the block body part according to an embodiment of the present disclosure. Referring to FIG. 8, the pump flow channel part 35 may include a first pump flow channel part 351, a second pump flow channel part 352, and a third pump flow channel part 353. Oil having pressure increased by the master cylinder part 20 may be supplied to the electric pump part 90. Oil that is discharged by the electric pump part 90 may be moved to the wheel cylinder part 40 through the pump flow channel part 35.

The first pump flow channel part 351 may provide oil that is discharged by the electric pump part 90 with guidance. The first pump flow channel part 351 may be disposed closely to the electric pump part 90. The second pump flow channel part 352 may be connected to the wheel flow channel part 33. The third pump flow channel part 353 may connect the first pump flow channel part 351 and the second pump flow channel part 352. A space on which the variable valve part 50 may be mounted may be formed in the third pump flow channel part 353. The third pump flow channel part 353 may be disposed between the first pump flow channel part 351 and the second pump flow channel part 352. An inside diameter of the third pump flow channel part 353 may be designed to be greater than an inside diameter of each of the first pump flow channel part 351 and the second pump flow channel part 352.

A fourth pump flow channel part 354 may be formed so that the variable valve part 50 is inserted into the third pump flow channel part 353. A fifth pump flow channel part 355 that is mounted on the fourth pump flow channel part 354 may support the variable valve part 50. A hole may be formed at a central part of the fifth pump flow channel part 355. The hole may become the first pump flow channel part 351.

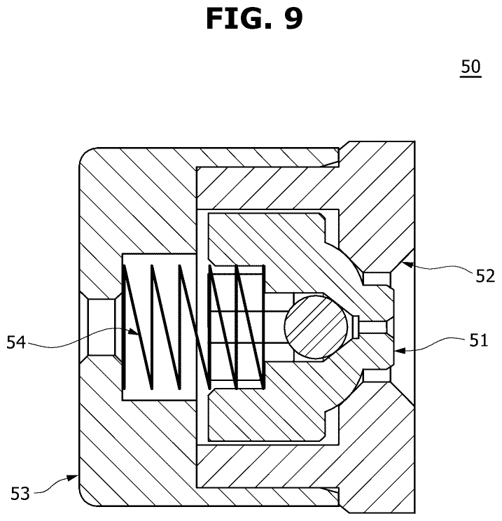

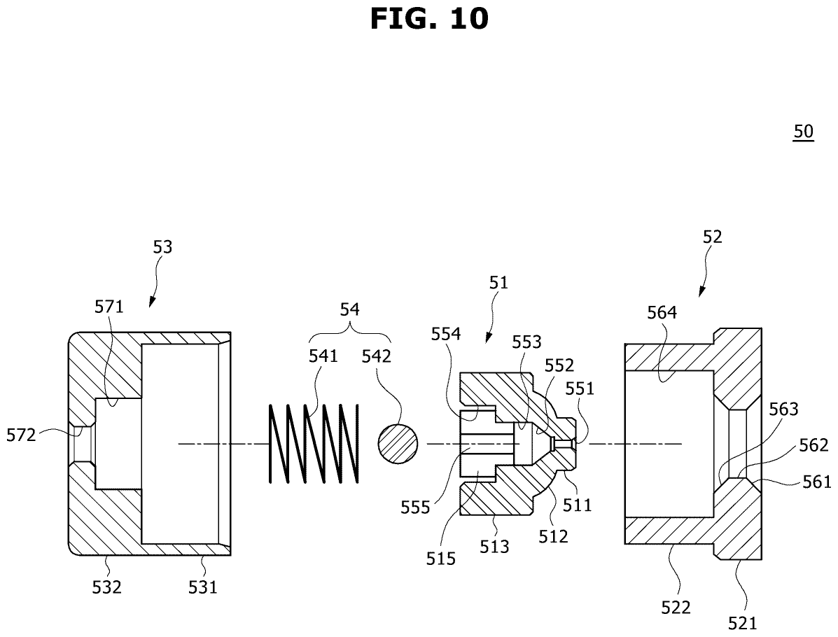

FIG. 9 is a combined cross-sectional view schematically illustrating the variable valve part according to an embodiment of the present disclosure. FIG. 10 is an exploded cross-sectional view schematically illustrating the variable valve part according to an embodiment of the present disclosure. Referring to FIGS. 9 and 10, the variable valve part 50 according to an embodiment of the present disclosure may include an internal valve part 51, an external valve part 52, a cover valve part 53, and an adjustment valve part 54.

The internal valve part 51 may transmit oil through a central part thereof. The central part of the internal valve part 51 may be opened and closed by the pressure of the adjustment valve part 54 and the second pump flow channel part 352. A hole may be formed at the central part of the internal valve part 51 so that a small amount of oil passes through the hole.

The external valve part 52 may surround the internal valve part 51, and may transmit oil through the inside thereof. An outside diameter of the external valve part 52 may be designed to be greater than an outside diameter of the internal valve part 51 so that an outer oil flow path is defined therebetween. The internal valve part 51 may be movably supported in the external valve part 52 so that it can move between a first position, or closed position, at which the internal valve part 51 contacts the external valve part 52 and the outer oil flow path is closed, and a second position, or open position, at which the internal valve part 51 is spaced apart from the external valve part 52 and the outer oil flow path is open. When the pressure of oil that is supplied by the first pump flow channel part 351 rises, the internal valve part is moved toward the open position and oil may pass between the internal valve part 51 and the external valve part 52.

The cover valve part 53 may be attached to the external valve part 52, and may define an opening via which oil leaves the variable valve part 50. The cover valve part 53 may restrict movement of the internal valve part 51 in the external valve part 52 by covering an end of the external valve part 52.

The adjustment valve part 54 may be disposed between the internal valve part 51 and the cover valve part 53, and may adjust an oil movement path by supporting the internal valve part 51. For example, the adjustment valve part 54 may bias the internal valve part 51 toward the external valve part 52 and toward the closed position. The adjustment valve may be configured to support the internal valve part 51 and bias the internal valve part 51 toward the closed position elastically. In addition, the adjustment valve part 54 may block the countercurrent of oil while being moved by the pressure of the oil in the internal valve part 51.

The internal valve part 51 according to an embodiment of the present disclosure may include an internal inlet part 511, an internal open and close part 512, and an internal expansion part 513.

The internal inlet part 511 may be disposed within the external valve part 52, and may transmit oil that is discharged by the electric pump part 90. A first internal hole 551 through which oil passes may be formed at a central part of the internal inlet part 511. An outer circumferential surface of the internal inlet part 511 may be isolated from the external valve part 52.

The internal open and close part 512 may be extended from the internal inlet part 511, and may transmit oil. When the outside of the internal open and close part 512 comes into contact with the external valve part 52, the internal open and close part 512 may block a movement of oil between the internal valve part 51 and the external valve part 52. The internal open and close part 512 may be extended toward the second pump flow channel part 352. The internal open and close part 512 may have a greater outside diameter than the internal inlet part 511. The outside of the internal open and close part 512 may have a curved shape. A second internal hole 552 that communicates with the first internal hole 551 and that has an inside diameter extended toward the second pump flow channel part 352 may be formed within the internal open and close part 512. An incline may be formed in the second internal hole 552 in a cross section thereof.

The internal expansion part 513 may be extended from the internal open and close part 512, and may transmit oil. An outside diameter of the internal expansion part 513 may be designed to be smaller than an inside diameter of the internal open and close part 512, so that oil may pass between the internal expansion part 513 and the internal open and close part 512. The internal expansion part 513 may include a third internal hole 553 that communicates with the second internal hole 552 and a fourth internal hole 554 that communicates with the third internal hole 553 and that has a greater inside diameter than the third internal hole 553. A short step may be formed due to a difference between the inside diameters of the third internal hole 553 and the fourth internal hole 554. A fifth internal hole 555 that induces oil to be moved toward the second pump flow channel part 352 may be formed within the third internal hole 553 and the fourth internal hole 554. The fifth internal hole 555 may have a form in which a plurality of grooves has been isolated from each other on an inner circumferential surface of the internal expansion part 513 in a circumferential direction thereof. The fifth internal hole 555 may be formed in the internal insertion part 515 that is inserted into the fourth internal hole 554.

The external valve part 52 according to an embodiment of the present disclosure may include an outside support part 521 and an outside duct part 522.

The outside support part 521 may be isolated from the internal inlet part 511 and closely attached to the internal open and close part 512. The outside support part 521 may include a first outside hole 561, a second outside hole 562, and a third outside hole 563. The first outside hole 561 may provide oil that is supplied by the first pump flow channel part 351 with guidance, and may have an inside diameter reduced toward the second pump flow channel part 352. The second outside hole 562 may communicate with the first outside hole 561, and may have an inside diameter greater than the outside diameter of the internal inlet part 511. The third outside hole 563 may communicate with the second outside hole 562, and may have an inside diameter reduced toward the second pump flow channel part 352. When the internal open and close part 512 is closely attached to the third outside hole 563, oil may move through the first internal hole 551.

The outside duct part 522 may be extended from the outside support part 521, may surround the internal expansion part 513, and may provide oil that passes between the outside support part 521 and the internal open and close part 512 with guidance. A fourth outside hole 564 may be formed in the outside duct part 522. An inside diameter of the outside duct part 522 may be greater than the outside diameter of the internal expansion part 513, so that oil may pass between the outside duct part 522 and the internal expansion part 513.

The cover valve part 53 according to an embodiment of the present disclosure may include a cover coupling part 531 and a cover extension part 532.

The cover coupling part 531 may be combined with the outside duct part 522. The cover coupling part 531 may be formed to surround an outer circumferential surface of the outside duct part 522. The cover coupling part 531 may be combined with the outside duct part 522 by a screw or may be assembled with the outside duct part 522 by a hook. In addition, the cover coupling part 531 and the outside duct part 522 may be combined in various ways.

The cover extension part 532 may be extended from the cover coupling part 531, and may transmit oil. The cover extension part 532 may include a first cover hole 571 and a second cover hole 572. The first cover hole 571 may communicate with the fourth internal hole 554. The diameter of the first cover hole 571 may be designed to be greater than the diameter of the fourth internal hole 554 and to be smaller than the diameter of the fourth outside hole 564. The second cover hole 572 may communicate with the first cover hole 571, and may discharge oil that passes through the first cover hole 571 to the second pump flow channel part 352. The second cover hole 572 may be formed to have a smaller diameter than the first cover hole 571, so that a short step may be formed at a boundary point between the second cover hole 572 and the first cover hole 571.

The adjustment valve part 54 according to an embodiment of the present disclosure may include an adjustment elastic part 541. The adjustment elastic part 541 may be disposed between the cover extension part 532 and the internal expansion part 513, and may elastically support the internal expansion part 513. The adjustment clastic part 541 may have a coil spring shape. The adjustment elastic part 541 may be inserted into the first cover hole 571 and the fourth internal hole 554. The adjustment elastic part 541 may elastically support the internal expansion part 513. The adjustment elastic part 541 may be formed to surround the internal insertion part 515.

The adjustment valve part 54 according to an embodiment of the present disclosure may further include an adjustment ball part 542. The adjustment ball part 542 may open and close a flow channel by being moved by the pressure of oil within the internal open and close part 512. The adjustment ball part 542 may be moved between the second internal hole 552 and the third internal hole 553. The adjustment ball part 542 can prevent the countercurrent of oil by coming into contact with an inner circumferential surface of the internal open and close part 512, which forms the second internal hole 552. The adjustment ball part 542 may be moved by the pressure of oil that is supplied through the first pump flow channel part 351, and may be supported by the adjustment elastic part 541 or the internal insertion part 515. When the adjustment ball part 542 is supported by the adjustment elastic part 541 or the internal insertion part 515, the oil may be moved through the fifth internal hole 555.

In a flow channel that is formed in the braking apparatus 1 for a vehicle and that provides oil with guidance, a pulsation phenomenon can be reduced because one or more variable valve parts 50 are installed in the wheel flow channel part 33 and the supply flow channel part 34 in addition to the pump flow channel part 35. In this case, a detailed construction of the variable valve part 50 is identical with that described with reference to FIGS. 9 and 10, and thus a detailed description thereof is omitted.

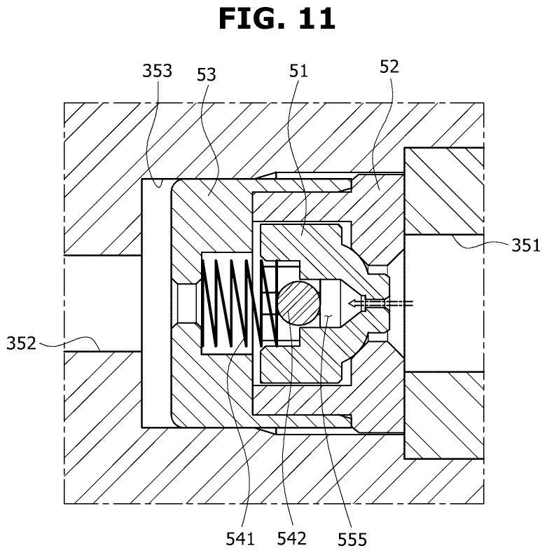

FIG. 11 is a diagram schematically illustrating the state in which a small amount of oil passes through the variable valve part according to an embodiment of the present disclosure. Referring to FIG. 11, in a low RPM area of the electric pump part 90, the pressure of oil that has entered the first pump flow channel part 351 is smaller than a restoring force of the adjustment clastic part 541 that elastically supports the internal valve part 51. At this time, an external surface of the internal open and close part 512 is closely attached to the outside support part 521. Accordingly, oil that has been introduced into the first internal hole 551 may push the adjustment ball part 542, may pass through the fifth internal hole 555, and may then pass through the cover valve part 53 and enter the second pump flow channel part 352.

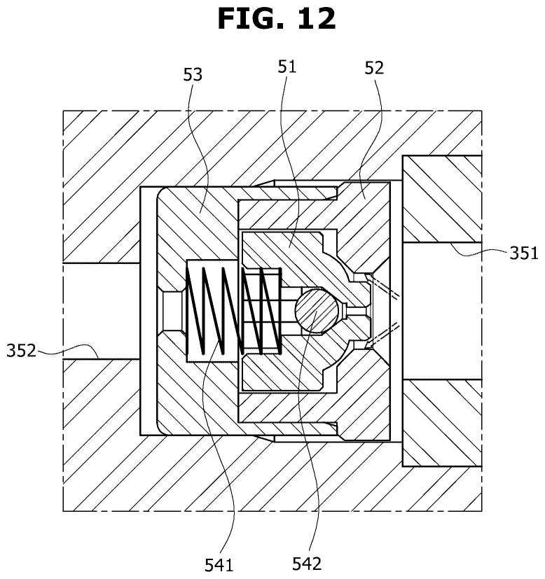

FIG. 12 is a diagram schematically illustrating the state in which a large amount of oil passes through the variable valve part according to an embodiment of the present disclosure. Referring to FIG. 12, in a high RPM area of the electric pump part 90, the pressure of oil that has entered the first pump flow channel part 351 is greater than the restoring force of the adjustment elastic part 541 that elastically supports the internal valve part 51. Accordingly, as the adjustment elastic part 541 is contracted, the external surface of the internal open and close part 512 is isolated from the outside support part 521. Furthermore, the oil may pass between the internal valve part 51 and the external valve part 52, and may then pass through the cover valve part 53 and enter the second pump flow channel part 352. At this time, some of the oil may push the adjustment ball part 542, may pass through the fifth internal hole 555, and may then pass through the cover valve part 53 and enter the second pump flow channel part 352.

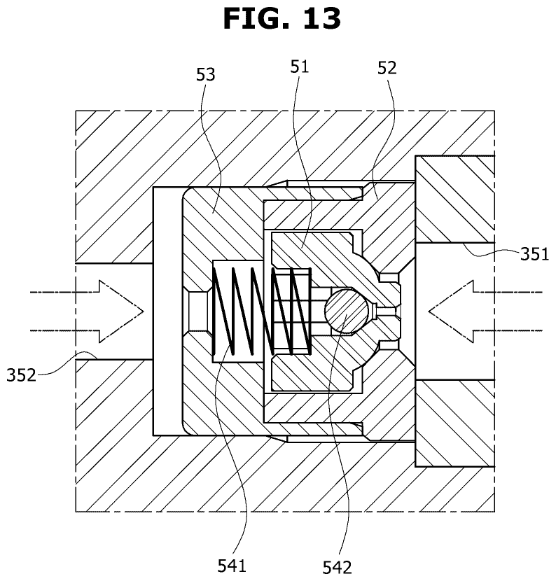

FIG. 13 is a diagram schematically illustrating the state in which the countercurrent of oil through the variable valve part according to an embodiment of the present disclosure is prevented. Referring to FIG. 13, when the driving of the electric pump part 90 is stopped, the adjustment ball part 542 is closely attached to the inner wall of the internal open and close part 512 by the pressure of oil through the second pump flow channel part 352. Accordingly, the countercurrent of the oil can be prevented because the first internal hole 551 is closed.

In the braking apparatus 1 for a vehicle according to an embodiment of the present disclosure, a plurality of oil paths can be designed because the electric pump part 90 is mounted on the block part 30 and partitions the chamber. Pressure pulsation amplitude can be reduced because an oil movement path is varied depending on a flow rate of oil.

Although embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A braking apparatus for a vehicle, comprising:
a pedal part;
a master cylinder part configured to receive oil and amplify a pressure of the oil based on pressure applied to the pedal part;
a block part connected to the master cylinder part, the block part being supplied with the oil from the master cylinder;
an electric pump part, within the block part, configured to amplify a pressure of the oil in the block part; and
a wheel cylinder part configured to receive pressurized oil from the block part and generate a braking force for a wheel of the vehicle in response to receiving the pressurized oil,
wherein the block part defines a space into which the electric pump part is received,
wherein the block part defines a plurality of oil movement paths fluidly connected to the space and separated from each other when the electric pump part is within the space.

2. The braking apparatus of claim 1, wherein:
the block part comprises a block body part,
the space comprises a pump port, and
the plurality of oil movement paths include:
a wheel flow channel that receives oil from the master cylinder and guides the oil to the wheel cylinder part;
a supply flow channel that fluidly connects the wheel flow channel to the pump port and is configured to supply oil for the electric pump part inserted therein; and
a pump flow channel that fluidly connects the pump port to the wheel flow channel and configured to guide oil discharged by the electric pump part from the pump port to the wheel flow channel.

3. The braking apparatus of claim 2, wherein the pump port comprises:
a pump mounting port formed in a first surface of the block body part; and
a pump connection port formed in a second surface of the block body part configured to communicate with the pump mounting port, and fluidly connected to the supply flow channel part, the wheel flow channel part, and the pump flow channel part.

4. The braking apparatus of claim 3, wherein the pump connection port comprises:
a first chamber configured to fluidly communicate with the pump mounting port;
a second chamber configured to fluidly connect the first chamber part with the supply flow channel;
a third chamber configured to fluidly connect the second chamber with the wheel flow channel part; and
a fourth chamber configured to fluidly connect the third chamber part with the pump flow channel.

5. The braking apparatus of claim 4, wherein:
an inside diameter of the second chamber is greater than an inside diameter of the first chamber,
an inside diameter of the third chamber is greater than the inside diameter of the second chamber, and
an inside diameter of the fourth chamber is greater than the inside diameter of the third chamber.

6. The braking apparatus of claim 5, wherein an incline is formed at a boundary between the third chamber and the fourth chamber.

7. The braking apparatus of claim 4, wherein the electric pump part comprises:
an electric part mounted in the pump mounting port for introducing oil to the pump; and
a pump part mounted in the pump connection port and configured to discharge oil that is introduced by the electric part.

8. The braking apparatus of claim 7, wherein the pump part comprises:
a pump compression part inserted into the first chamber and the second chamber and configured to raise pressure of oil that is introduced into the second chamber;
a pump guide part connected to the pump compression part and configured to seal the third chamber and to guide oil that is discharged by the pump compression part therethrough; and
a pump discharge part connected to the pump guide part and inserted into the fourth chamber the pump discharge port being configured to discharge oil that passes through the pump guide part.

9. The braking apparatus of claim 1, further comprising a variable valve part mounted on the block part and configured to adjust an amount of passage of oil based on a flow rate of the oil that is discharged by the electric pump.

10. The braking apparatus of claim 9, wherein the variable valve part comprises:
an external valve part via which oil enters the variable valve part;
an internal valve part movably supported within the external valve and defining an inner oil flow path through a central portion of the internal valve part, the internal valve part being supported such that an outer oil flow path is defined between an inner surface of the external valve part and an outer surface of the internal valve part, the internal valve part being movable between a first position at which the outer flow path is closed and a second position at which the outer flow path is open; a cover valve part attached to the external valve part and defining an open via which oil received from the inner oil flow path and the outer oil flow path is discharged from the variable valve part; and
an adjustment valve part disposed between the internal valve part and the cover valve part and configured to bias the internal valve part toward the first position.
